(19) United States
(12) Patent Application Publication
(10) Pub. No.: US 2007/0020587 A1
(43) Pub. Date: Jan. 25, 2007

(54) Interactive motion simulator

(76) Inventors: Michael Z. Seymore, Grand Rapids, MI (US); Dennis W. Duimstra, Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/194,937

(22) Filed: Aug. 2, 2005

Related U.S. Application Data
(60) Provisional application No. 60/598,980, filed on Aug. 5, 2004.

(51) Int. Cl. G09B 9/02

(52) U.S. Cl. 434/29

(57) ABSTRACT

A motion simulator includes a base frame and a pitch frame pivotally mounted to the drive frame. Opposite ends of a drive coupling is coupled to ends of the pitch frame for tilting the pitch frame fore and aft. A cradle for supporting an occupant capsule is rotatably mounting to the pitch frame for rotation on an axis orthogonal to the pivot axis of the pitch frame. A roll motor is mounted to the pitch frame and coupled to one of the axles associated with the cradle for rotating the cradle and capsule. Signals from control circuits within the capsule are supplied to an operator console through a slip ring connection to allow 360 degree rotation.

### CROSS-REFERENCE TO RELATED APPLICATION

This application claims priority under 35 U.S.C. § 119(e) on U.S. Provisional Application Ser. No. 60/598,980 entitled Interactive Motion Simulator, filed on Aug. 5, 2004, by Michael Z. Seymore, et al., the entire disclosure of which is incorporated herein by reference.

### BACKGROUND OF THE INVENTION

The present invention relates to a motion simulator and, more specifically, to an interactive motion simulator.

In general, a large majority of known motion simulators have been passive devices that have operated on multiple phase electrical power or employed hydraulic cylinders. Typically, known motion simulators which provide realistic pitch and roll motions are relatively large and, as such, not readily transportable. Such large motion simulators generally require disassembly and reassembly when moved from one location to another. Smaller, relatively simple readily transportable manual devices are very limited in the motion that they provide.

One portable flight simulator includes a conventional vehicle trailer for storage and transportation to various sites. The portable flight simulator is hydraulically controlled and includes a folding video screen, which, when erected, provides a relatively wide field of view for an operator of the simulator. The simulator includes a conventional personal computer that implements a flight simulator program that provides a video signal for a projector, which projects video programs onto the screen, for viewing by the operator. During operation of the simulator, the operator utilizes a control stick to change operator orientation in reaction to the video program. The flight simulator may also include an audio output that provides sound effects. Due to the use of a crank arm and cylinder, the roll arc is somewhat limited.

A two seat interactive simulator has been proposed that allows one or more operators to play a simulation game running on a separate display screen. Each operator can alternately control, via joysticks, the pitch and roll of a small motion-based platform that supports a vehicle in which the operators sit. The joysticks, which are mounted in front of each player, allow a player to move the vehicle forward, backward, side-to-side and rotate in a 360 degree horizontal circle to cause the platform to pitch and roll. The joysticks also have separate buttons for firing weapons at targets on the display screen, and controlling the position and speed of the images on the screen. As is disclosed, the interactive simulator may simulate a variety of vehicles, e.g., a helicopter, an airplane, a jet, an automobile, a motorcycle, a truck, a military tank, a speedboat, a submarine and a jet ski. It does not, however, provide for inverted flight or 360 degree rolls.

An arcade amusement ride motion simulator system has been proposed that includes a base and a capsule that is capable of limited roll, pitch and yaw angular motions about a pivot point at the center of the capsule using hydraulic actuators. The simulator includes three actuators that are operatively arranged to selectively move the capsule relative to the base in any of four degrees of freedom.

While many of the prior art motion simulators provide some pitch and yaw motion, they are limited in the motion they provide and/or are relatively large, difficult to relocate, and expensive to maintain. There exists a need, therefore, for a motion simulator that provides relatively complex realistic movement, including 360 degree rolls, and which is readily transportable, durable, and relatively inexpensive to maintain.

### SUMMARY OF THE INVENTION

The present invention provides a motion simulator which is fully interactive for one or more players and is capable of performing a 360 degree barrel roll at the operator's command.

In one embodiment, the motion simulator includes a base frame having a drive motor and an output drive mounted to the base frame. A drive coupling is operatively coupled to the output drive. A pitch frame has a pair of inverted V-shaped sides and end members and is pivotally mounted to the drive frame, with opposite ends of the drive coupling being coupled to the end members of the pitch frame for tilting the pitch frame fore and aft. A cradle for supporting an occupant capsule includes a pair of axles for rotatably mounting the cradle between the end members of the pitch frame for rotation on an axis generally orthogonal to the pivot axis of the pitch frame with respect to the base. A roll motor is mounted to the pitch frame and coupled to one of the axles associated with the cradle for rotating the cradle and capsule. In a preferred embodiment, the drive coupling includes at least one toothed drive belt. An electrical coupling between a control member in the capsule and the external control circuits allow 360 degree rolls of the capsule. With this system, a relatively compact, durable, practically maintenance-free, portable motion simulator is provided which employs 110 VAC motors and yet provides a full range of motion including the ability to do continuous 360 degree rolls.

These and other features, objects and advantages of the present invention will become apparent upon reading the following description thereof together with reference to the accompanying drawings.

### BRIEF DESCRIPTION OF THE DRAWINGS

FIG. 1 is a perspective view of the motion simulator of the present invention;

FIG. 2 is a block electrical circuit diagram of the major electrical components associated with the motion simulator;

FIGS. 3A and 3B are an exploded perspective view of the major structural components of the motion simulator;

FIG. 4 is a perspective assembled view of the major components of the motion simulator, partly broken away;

FIG. 5 is a right side elevational view of the motion simulator, shown in an at rest horizontal position;

FIG. 6 is a right side elevational view of the motion simulator, shown in a forwardly pitched position;

FIG. 7 is a front elevational view of the motion simulator, shown in a horizontal position;

FIG. 8 is a front elevational view of the motion simulator, shown in a 45 degree rotated position;

FIG. 9 is a fragmentary rear elevational view of the motion simulator with the tail piece removed;

FIG. 10 is a fragmentary perspective view of the adjustment mechanism for the drive belts;

FIG. 11 is an enlarged fragmentary cross-sectional view of the drive belt adjustment, taken along section lines XI-XI in FIG. 10, in a first position; and

FIG. 12 is the enlarged fragmentary cross-sectional view of FIG. 11, showing the adjustment mechanism in a second adjusted position.

### DETAILED DESCRIPTION OF THE PREFERRED EMBODIMENT

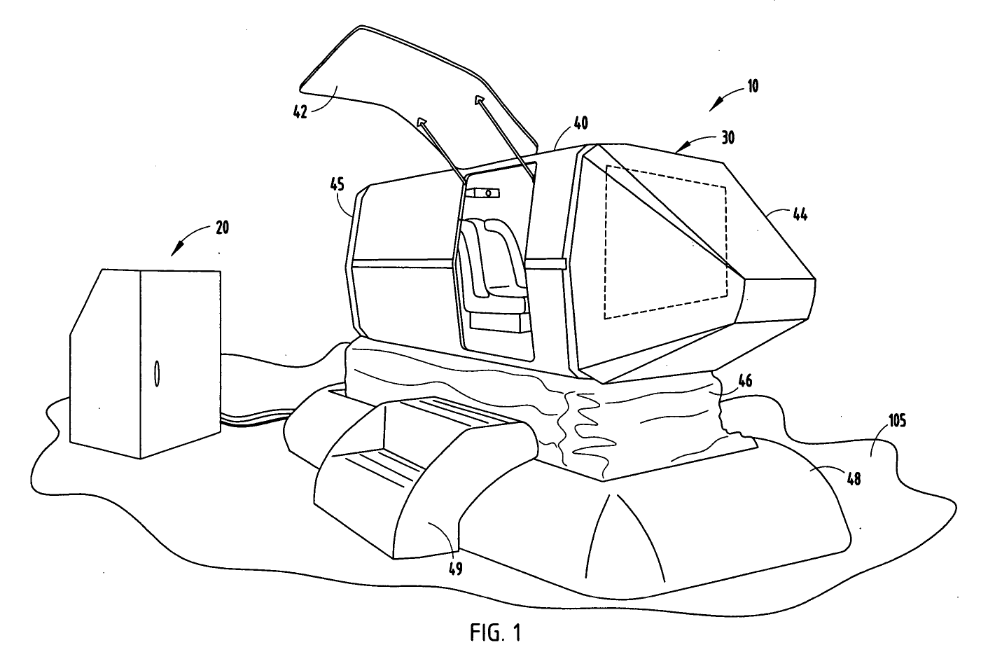

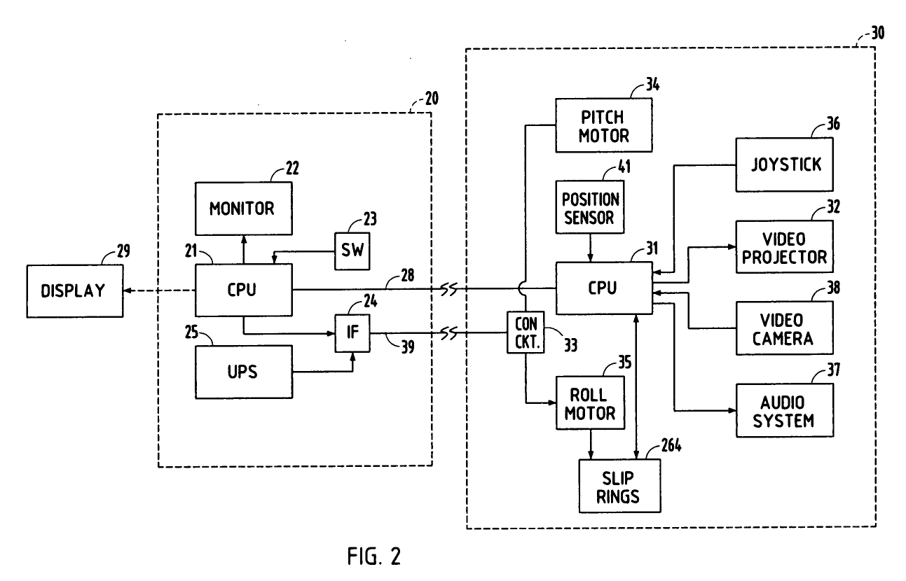

FIG. 1 shows the interactive motion simulator system 10 of the present invention, which includes a control console 20 and a motion simulator module 30. As seen in FIG. 2, the control console 20 includes a microprocessor or CPU 21, a monitor 22, operator control switches 23 coupled to the CPU, an interface circuit 24, and a universal power supply (UPS) 25. The interface circuit is coupled to a pitch motor and roll motor control circuit 33. Microprocessor 21 is coupled to a corresponding microprocessor 31 in the motion simulator module 30 through a conventional Ethernet connection 28. Microprocessor 31 includes a hard drive having graphic video programming for projecting on a video projector 32 contained within the capsule of the simulator module a topographical screen of terrain, other flying objects, and providing flight simulation motion. The simulator system also includes, as described in detail below, a pitch motor 34, a roll motor 35, and a pair of controlling joysticks 36 allowing a pilot and gunner to provide the interactive control of the module 30. An audio system 37 is also coupled to the CPU to receive realistic flight sounds as well as target interception simulation audio effects. Finally, a capsule video camera 38 is included within the module 30 to provide a video of the occupants of the module which can be supplied back through the Ethernet connection 28 between microprocessor 21 and 31 to an external display panel 29, which is in the vicinity of the system 10 and displays to awaiting customers the activities of the current occupants of the module to provide additional excitement for the flight experience. Position sensors 41 are located between movable elements of the system to detect travel limits or center locations of the capsule. Also, a slip ring assembly 264 couples signals to the capsule electrical components from the external electrical controls to allow 360 degree rotation of the capsule.

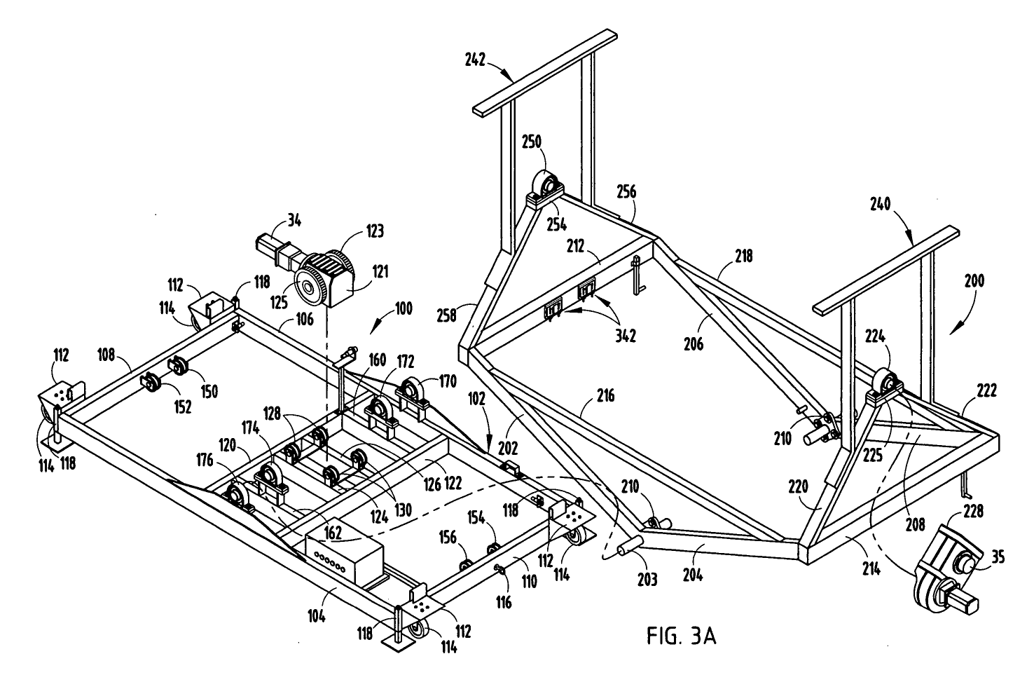

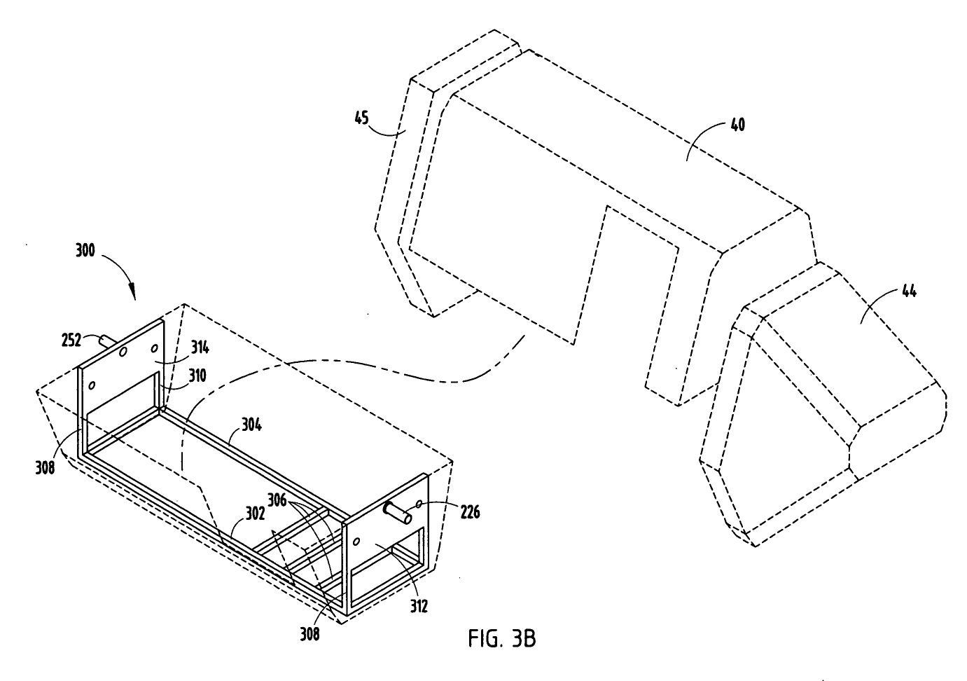

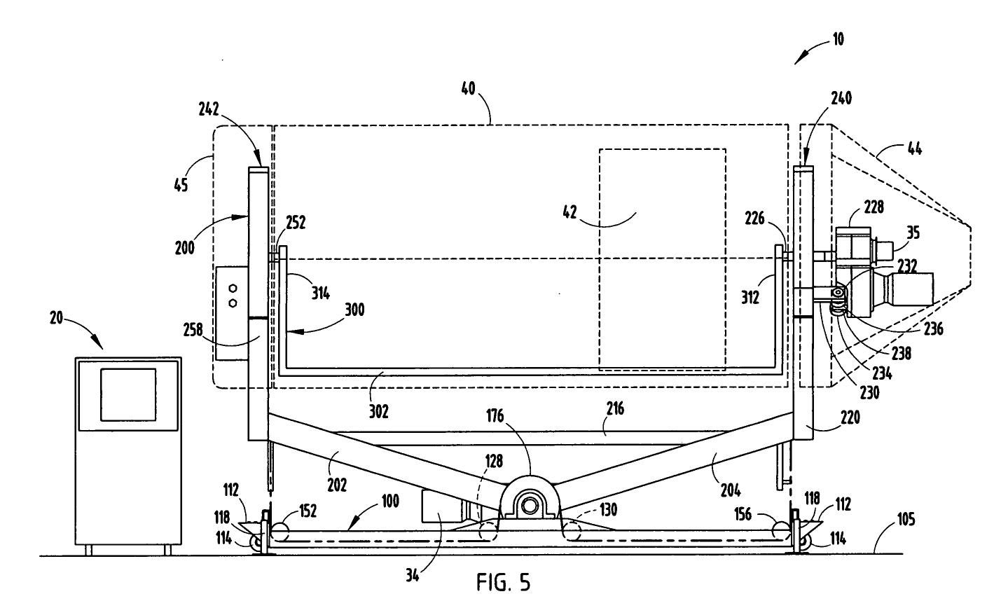

The motion simulator module 30 includes a base frame 100 (FIG. 3) on which a pitch frame assembly 200 is pivotally mounted and to which, in turn, a cradle 300 is rotatably mounted as described below. The module includes a capsule 40, as seen in FIG. 1, with a closable access door 42, a nose piece 44 which is mounted to the pitch frame, and includes the roll motor 35 for rolling the capsule 40 in response to the operation of the pilot's joystick. The module 30 also includes a tail piece 45 enclosing the opposite end of the pitch frame and bearings for rolling the capsule 40. A flexible shroud 46 extends from the capsule to a decorative base cover 48 which includes removable admission steps 49 for access to the capsule door 42. In operation, the entire module, including capsule 40, nose piece 44, and tail piece 45, will pitch upwardly approximately 20 degrees and downwardly approximately 20 degrees from the center location shown in FIGS. 1 and 5 during operation. Additionally, under the influence of the joystick and roll motor 35, the capsule 40 will rotate-through a 360 degree arc continuously (if desired) with respect to the nose piece 44 and tail piece 45, although a typical hard bank turn will require a rotation of only about 60 degrees.

The motion simulator module 30 is approximately 6′8″ in height and has width of approximately 4′6″, a length of 11′7″ and a weight of approximately 1800 pounds. The power required is three 110 volt, 20 amp power supplies, one for the control counsel 20 and two for the motion simulator module 30 to provide operating power to the pitch motor 34 and roll motor 35. In the event of a loss of power, the universal power supply 25 will right the module to its neutral, horizontal position, as seen in FIG. 1.

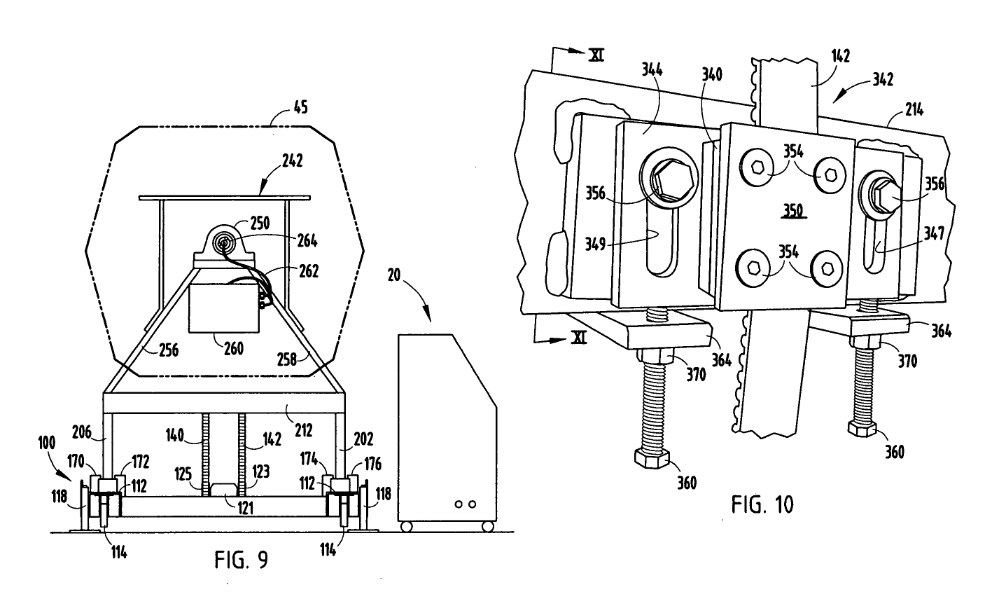

The module microprocessor 31 is programmed with a flight combat game similar to Microsoft flight simulator 2000 with the addition of interactive inputs from the joysticks employed by the pilot and gunner in the capsule. The signals received from the operators are transmitted to the control console CPU 21 through the slip rings 264 and an Ethernet connection 28. For example, if the pilot wants to bank the simulator through a turn of 60 degrees, the joystick signal would be sent to the CPU 21 through the Ethernet connection 28. CPU 21, in turn, responds to supply a signal to the interface circuit 24 and suitable servo motor control circuits 33 via conductors 39 in cable 262 (FIG. 9) through the slip rings 264. Both the servo pitch motor 34 and servo roll motor 35 achieve the desired turning and banking (i.e., elevation and 60 degree roll) of the capsule 40 of module 30. The pitch servo motor control drive 33 is also coupled to an encoder, which provides feedback to the pitch servo motor control drive to indicate a current position of the capsule. The roll servo motor control drive 33 also receives output from an encoder associated with the roll motor 35, such that the roll motor control drive can determine the current state of the roll motor and, thus, the current state of the position of the capsule responsive to input received from an operator of the capsule via joystick 36. Having described the overall system components, a detailed description of the construction of the simulator now follows.

The underlying structural components of the module include a base frame 100 (FIG. 3A) which comprises a generally rectangular frame 102 having a pair of longitudinal struts 104, 106 and end cross beams 108 and 110 complete the outer rectangular frame 102. The frame members comprise in one embodiment 2×4 tubular steel members which are suitably treated for environmental durability, such as by painting. Each corner of the frame 102 includes a plate 112 to which a caster 114 is mounted to allow the flight simulator 30 to be easily moved. An eye bolt 116 is mounted to the end beams 108, 110 to allow the module to be pulled onto a trailer using a conventional cable wench. Each of the plates 112 also include a screw jack 118, such that once the module has been moved to a site for use, the screw jacks are lowered to stabilize frame 102 on a support surface such as the floor 105 shown in FIG. 1.

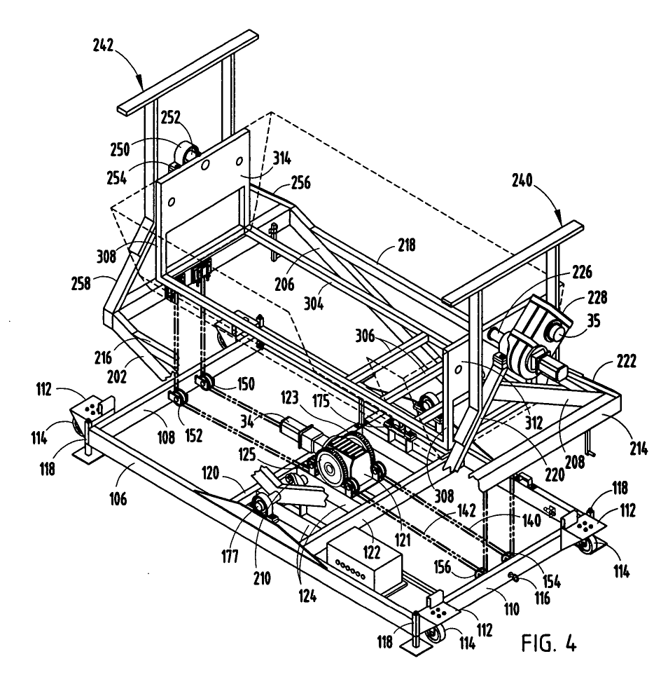

Base 100 also includes near the center thereof a pair of spaced-apart cross beams 120, 122 and struts 124, 126, which support an electrically driven 1.5 hp servo pitch motor 34 and dual axle SEW Eurodrive 130:1 gear box 121 with drive gears 123 and 125. Struts 124 and 126 each include a pair of guide rollers 128 and 130 to guide a respective timing drive belt 140 and 142 (FIG. 4) around the timing drive belt drive gears 123 and 125, respectively, of pitch motor gear box 121. This maintains drive belts 140 and 142 in engagement with gears 123 and 125, as seen in FIG. 4. The drive belts subsequently extend through a pair of secondary guide pulleys 150 and 152 coupled to end member 108 and 154 and 156 coupled to end member 110 to guide the belts in an upward direction to the pivot frame assembly 200, as seen in FIGS. 3A and 4.

Base 100 also includes cross struts 160 and 162 extending between cross beams 120 and 122 and spaced inwardly from longitudinal beams 104 and 106 to receive pairs of pillow blocks 170, 172 and 174, 176, respectively, for securing therebetween in fixed relationship a pair of pivot stub axles 175 and 177, respectively. As seen in FIGS. 3A and 4, the space between pillow blocks 174 and 176 is selected to receive the bearing 210 of the pitch frame 200 on each of the longitudinal beams 104, 106 to provide a pivot connection between the pivot frame 200 and the base frame 100.

The pitch frame 200 comprises a pair of inverted V-shaped sides, which allow the significant tilting (pitching) of the capsule 40 during operation. The frame is made of channel iron, including members 202 and 204 on one side which join together at an apex 203 intersecting at an angle of about 120 degrees at which location the pivot rod receiving bearing 210 is mounted. The opposite side of frame 200 also includes a pair of struts 206 and 208 intersecting to form a V-shape and also includes a pivot rod receiving bearing 210. The struts 202, 204, 206, and 208 terminate and are coupled to cross beams 212 and 214 while a pair of reinforcing horizontal struts 216 and 218 are coupled to members 202, 204 and 206, 208, respectively near the ends which intersect cross beams 212 and 214. One end of pitch frame 200 is aligned under the nose cone 44 and includes a triangular bracket defined by legs 220 and 222 extending upwardly from cross member 214, as seen in FIGS. 3A and 4. Members 220 and 222 terminate at an apex at their upper end to which there is mounted a bearing 224 on a mounting plate 225 for receiving the roll pivot axle 226, as seen in FIG. 4.

A 1.5 hp servo roll motor 35 is mounted to a 54:1 SEW Eurodrive gear box 228, in turn, mounted to frame member 220 by a mounting bracket 230 (FIG. 5) for aligning the drive shaft of the gear box 228 which is secured by a conventional keyway to roll axle 226, in turn, fixedly mounted to one end of the cradle 300 to which the capsule shell 40 of the module is mounted. Gear box 228 is mounted to bracket 230 by a bolt 232 and a pair of shock-mount washers 234 and 236, which extend on opposite sides of a mounting tab 238 on gear box 228 for securing the gear box to the triangular end of pitch frame 200. Pitch frame 200 also includes a generally rectangular frame 240 for securing the nose cone 44 thereto, such that the nose cone, which encloses the roll motor 35 and gear box 228, tilts with the module during its operation.

The opposite end of the pitch frame, which is covered by the tail piece 45 mounted to bracket 242 includes a pivot bearing 250 aligned to receive a pivot axle 252 coupled to the end wall 314 of the module holding cradle 300. Pivot bearing 250 is also mounted to a plate 254 (FIGS. 3A and 9) extending between the ends of the triangular support struts 256 and 258 extending upwardly from the cross member 212 of frame 200. A control circuit box 260 (FIG. 9) is also mounted to the members 256 and 258 and includes electrical conduits 262 coupled to a slip ring assembly 264. This connection is provided by forming an axial aperture in pivot axle 252 communicating with a radial aperture for allowing wires to be coupled to the commercially available slip ring assembly. Slip ring assembly 264 is available from Moog Components Group, Part No. AC6355-36X. The slip ring assembly supplies control signals to the electrical components contained in capsule 40 of module 30 continuously during rotation of the capsule to allow 360 degree rotation. In some embodiments, the electrical communication between the freely rotatable capsule and the other electrical controls either fixed to the pitch frame or base frame may be by a wireless interconnection using, for example, blue tooth technology. The interface circuit box 260 is coupled to the central console 20. Thus, pitch frame 200 provides a pair of rotating pivot stub axles 226 and 252 which support opposite ends of the cradle 300 to which the capsule 40 of the motion simulating module is attached.

The cradle 300 (FIGS. 3B and 4) includes a pair of longitudinal struts 302, 304 with a plurality of cross beams 306 which, together with beams 302 and 304, define a support for the floor surface (not shown) of the capsule. The ends of longitudinal struts 302 and 304 each include a pair of vertically extending legs 308 and 310, which support a mounting plates 312 and 314 to which the pivot stub axles 326 and 352 are fixedly mounted, as by welding or the like.

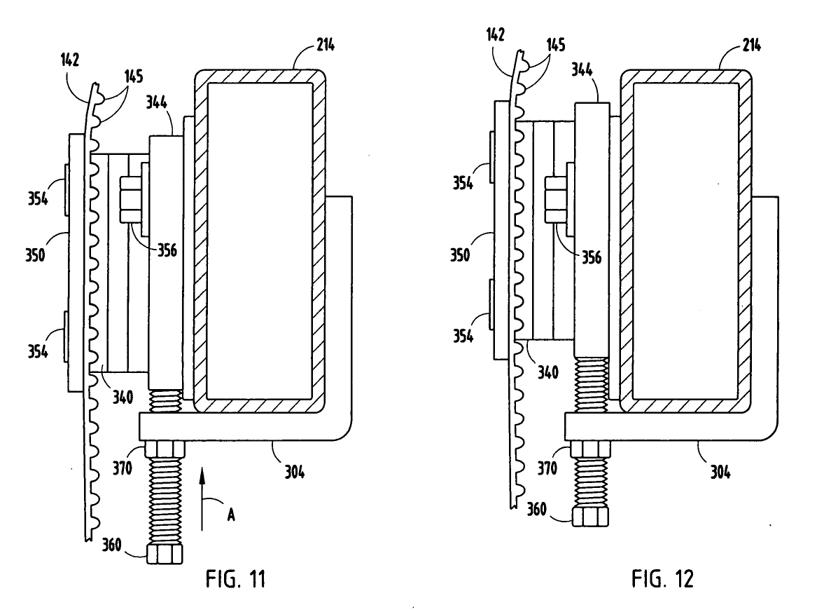

Each end of each of the drive belts 142 and 144 is fixedly but adjustably mounted to the ends of the pitch frame 200. FIGS. 10-12 show the details of one of the four identical mounts 342, which allows for the adjustment of the tension of the drive belts and their proper positioning during assembly and use. The drive belts each include a plurality teeth 145 which are interlockably engaged to a toothed pad 340 which, in turn, is secured to a sliding plate 344, including a pair of slots 347 and 349. The belts are lockably secured to sliding plate 344 and pads 340 by cover plate 350 by suitable fasteners, such as threaded screws 354. Sliding plate 344 is secured to cross beam 214 by means of bolts 356, which, when loosened, allows the plate 344 to move upwardly and downwardly, in the direction indicated by arrow A, thereby increasing or decreasing the tension on drive belts 142 and 144. To provide a fine adjustment to the belts, a pair of adjustment screws 360 associated with each of the adjustment plates 344 and extends through a mounting threaded bracket 364 to engage the lower edge of plates 344. The plates 344 can, therefore, be raised or lowered with the plate slots 347 and 349 riding along the bolts 356.

Once the proper tension (as, for example, for the 30 mm wide Kevlar belts shown) is provided with, for example, a one-inch deflection, a locking nut 370 on each of the adjustment screws 360, respectively, are tightened against mounting tabs 364, respectively, to secure the desired adjustment. Such adjustments may be necessary after initial set up and testing or after long term use and some stretching of the belts. Each end of each of the belts includes such an adjustment mechanism which can accommodate the desired range of adjustment to maintain the belt tension.

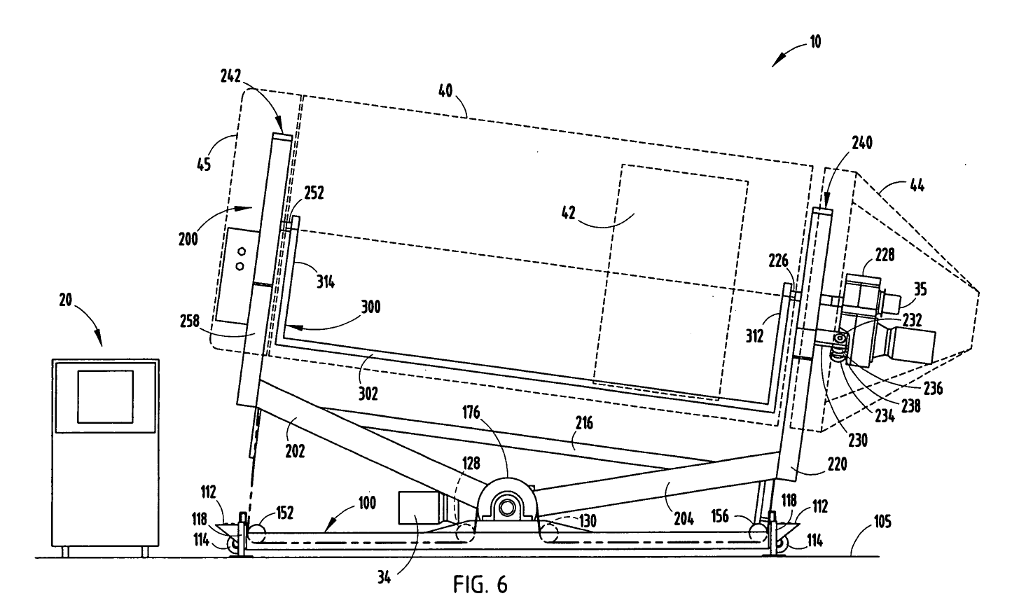

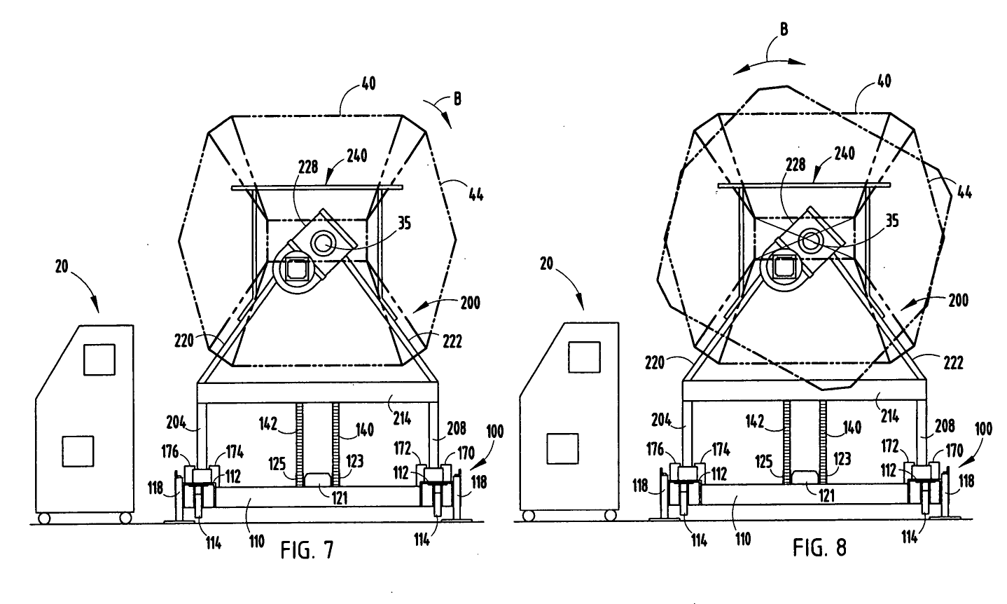

In operation, the rotation of the drive gears on pitch motor 34 causes the belts 140, 142 to move through the drive gears 123, 125 guided by guide rollers 128, 130, which maintain the timing belts in engagement with the drive gears such that the pitch frame and capsule mounted thereto tilts under the control of the rotation of the servo pitch motor 34, as illustrated in FIG. 6. Dual belts are provided for safety and backup. In the event that one of the belts should break, each belt is sufficiently robust that a single belt will control the capsule. Regardless of the tilted position of the pitch frame, the cradle 300 holding the capsule 40 can rotate continuously through 360 degrees in either direction, as seen by arrow B in FIGS. 7 and 8. The rotation is controlled by the operator (pilot) under the control of the joystick 36, which sends signals to CPU 31 and CPU 21 through a slip ring assembly 264 which provides continuous interconnection of the Ethernet connection 28 (FIG. 2) and control conductors 39 included in connecting cable 262 (FIG. 9). CPU 21, in turn, sends appropriate control signals through the interface 24 to the pitch and roll motor control circuit 33 to control the servo roll motor 35. The pivot axles 226 and 252 are driven by roll motor 35 and gear box 228 through the pivot bearings 224 and 250 at opposite ends of the pitch frame 200.

In order to initially center the module and also to control the maximum direction of tilt, sensors 41 (FIG. 2) are provided between the base 100 and pitch frame 200 at the travel limits of 20 degrees tilted either forwardly or rearwardly. Thus, sensors are fixed on opposite ends of the base and sensor actuators are fixed on opposite ends of the pitch frame such that, as the sensor actuator on the pitch frame approaches and comes in proximity to the sensor on the base, a signal is sent to the microprocessor 31 in the capsule indicating that the maximum tilt angle has been reached. A similar sensor and actuating arrangement is mounted on the cradle 300 and pitch frame 200 to detect and provide a control signal indicating when the capsule 40 is in a horizontal (or otherwise level) position, as seen in FIG. 5.

The pitch frame 200, cradle 300, and base frame 100 are all made of channel steel which is suitably treated for durability, while the skin of the capsule typically will be made of molded fiberglass. The capsule includes a floor, a mounting rack for the microprocessor 31 and control circuits as well as a rear projector which projects the topographical and flight images onto a screen in front of a pair of bucket seats for holding the pilot and gunner, which are restrained by seatbelts and other safety equipment. The capsule typically has a darkened interior and includes suitable cooling fans for the occupants as well as the electronic equipment contained therein. While the system is designed primarily for entertainment, it is sufficiently robust and realistic that it could also be used for flight training purposes. If power is interrupted, universal power source 25 automatically supplies operating power, which allows the system to return the capsule to a level position (FIG. 5), such that the occupants can safely exit the capsule in the event of lost power in a facility in which the simulator is being employed.

It will become apparent to those skilled in the art that various modifications to the preferred embodiment of the invention as described herein can be made without departing from the spirit or scope of the invention as defined by the appended claims.

The invention claimed is:

1. A motion simulator comprising:
a base frame;
a drive mounted to said base frame;
a pitch frame pivotally mounted to said drive frame and coupled to said drive for tilting said pitch frame relative to said base frame, said pitch frame having a pair of spaced-apart ends;
a cradle for holding an occupant capsule, said cradle associated with a pair of axles extending between said pitch frame and said cradle for rotatably mounting said cradle between said ends of said pitch frame for rotation on an axis generally orthogonal to the pivot axis of said pitch frame with respect to said base frame;
a roll motor mounted to said pitch frame and coupled to at least one of said axles associated with said cradle for rotating said cradle with respect to said pitch frame;
an occupant capsule coupled to said cradle and including a control member for controlling the motion of said capsule through said drive and said roll motor;
a control circuit remote from said capsule; and
an electrical coupling for coupling said control member to said control circuit.

2. The motion simulator as defined in claim 1 wherein said electrical coupling comprises a slip ring assembly coupled to one of said pivot axles associated with said cradle.

3. The motion simulator as defined in claim 2 wherein said drive includes a drive motor with an output drive mounted to said base frame and a drive member operatively coupled to said output drive.

4. The motion simulator as defined in claim 3 wherein said drive member includes at least one drive belt having opposite ends, and wherein said opposite ends are coupled to opposite ends of said pitch frame.

5. The motion simulator as defined in claim 4 wherein said output drive includes a drive gear which meshes with said toothed drive belt.

6. The motion simulator as defined in claim 5 and further including guide pulleys mounted to said base frame for guiding said toothed drive belt.

7. The motion simulator as defined in claim 6 wherein said pitch frame includes a pair of generally V-shaped sides.

8. A motion simulator comprising:
a base frame;
a drive motor mounted to said base frame and having an output drive with a drive gear;
a toothed drive belt operatively coupled to said output drive gear;
a pitch frame comprising a pair of sides and end members, wherein said pitch frame is pivotally mounted to said drive frame, and wherein opposite ends of said drive belt are coupled to said end members of said pitch frame;
a cradle associated with a pair of axles for rotatably mounting said cradle between said end members of said pitch frame for rotation on an axis generally orthogonal to the pivot axis of the pitch frame with respect to said base; and
a roll motor mounted to said pitch frame and coupled to at least one of said axles associated with said cradle for rotating said cradle with respect to said pitch frame.

9. The motion simulator as defined in claim 8 and further including a belt tensioning adjuster between at least one end of said belt and an associated end of said end member of said pitch frame.

10. The motion simulator as defined in claim 8 wherein said belt tensioning adjuster comprises a toothed plate meshing with the teeth of said drive belt, and wherein said toothed plate is slidably mounted to said end member.

11. The motion simulator as defined in claim 8 wherein said simulator includes a pair of parallel spaced toothed drive belts and said output drive includes a gear coupled to each drive belt.

12. The motion simulator as defined in claim 11 and further including guide pulleys on said base frame for holding said drive belts in engagement with said drive gears.

13. The motion simulator as defined in claim 12 and further including additional pulleys for training said drive belts in a direction toward said pitch frame.

14. The motion simulator as defined in claim 13 wherein said pitch frame comprises a pair of generally inverted V-shaped sides.

15. The motion simulator as defined in claim 14 and further including an occupant capsule coupled to said cradle and including a control member for controlling the motion of said capsule through said drive and said roll motor, a control circuit remote from said capsule, and an electrical coupling for coupling said control member to said control circuit.

16. The motion simulator as defined in claim 15 wherein said electrical coupling comprises a slip ring assembly coupled to one of said pivot axles associated with said cradle.

17. A motion simulator comprising:
a base frame;
a drive motor with an output drive mounted to said base frame;
a drive member operatively coupled to said output drive;
a pitch frame comprising a pair of generally inverted V-shaped sides and end members, wherein said pitch frame is pivotally mounted to said drive frame, and wherein opposite ends of said drive member are coupled to said end members of said pitch frame;
a cradle and a pair of axles extending between said cradle and said pitch frame for rotatably mounting said cradle between said end members of said pitch frame for rotation on an axis generally orthogonal to the pivot axis of said pitch frame with respect to said base frame; and
a roll motor mounted to said pitch frame and coupled to at least one of said axles associated with said cradle for rotating said cradle with respect to said pitch frame.

18. The motion simulator as defined in claim 17 and further including an occupant capsule coupled to said cradle and including a control member for controlling the motion of said capsule through said drive and said roll motor, a control circuit remote from said capsule, and an electrical coupling for coupling said control member to said control circuit.

19. The motion simulator as defined in claim 18 wherein said electrical coupling comprises a slip ring assembly coupled to one of said pivot axles associated with said cradle.

20. The motion simulator as defined in claim 17 wherein said drive member includes at least one drive belt having opposite ends, and wherein said opposite ends are coupled to opposite end members of said pitch frame.
